(19) United States
(12) Patent Application Publication
(10) Pub. No.: US 2005/0253808 A1
(43) Pub. Date: Nov. 17, 2005

(54) Input guide display operation system

(75) Inventor: Kenji Yoshida, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/127,313

(22) Filed: May 12, 2005

(30) Foreign Application Priority Data
May 14, 2004 (JP) 2004-145284

(51) Int. Cl. G09G 5/00

(52) U.S. Cl. 345/156

(57) ABSTRACT

A remote controller which allows one key to make touch and push inputs, and a TV that supports an instruction issued by that remote controller are used. If a touch input is made on the remote controller, a first display corresponding to this touch operation is made. If a push input is made on the remote controller in the first display, a second display or predetermined action is made.

### CROSS-REFERENCE TO RELATED APPLICATIONS

This application is based upon and claims the benefit of priority from prior Japanese Patent Application No. 2004-145284, filed May 14, 2004, the entire contents of which are incorporated herein by reference.

### BACKGROUND OF THE INVENTION

1. Field of the Invention

The present invention relates to an improvement of operability of remote control operations in a video apparatus such as a digital TV or the like and, more particularly, to an operation system of input guide display (graphical user interface: GUI) with the improved operability.

2. Description of the Related Art

In recent years, home video apparatuses have multifunctions owing to digitization, and their operations are complicated. For example, a single digital TV can receive broadcasting such as terrestrial/satellite analog broadcasting, terrestrial/satellite digital broadcasting, and the like, and can also make Internet communications and collaborations with various other digital apparatuses (DVD-VR recorder, personal computer, and the like). Normally, a remote controller is used to make user operations (text input as needed) of such video apparatus. However, remote control operations become complicated due to multifunctions and complicated operations of the apparatus. In addition, the number of operation buttons of a remote controller goes on increasing.

Since a remote controller with a limited size does not have an enough area to place such many operation buttons, some recent remote controllers commonly use one key to make a plurality of operations. For example, a double key structure remote control device which allows one key to make double actions, i.e., touch and push operations by combining a touch panel and operation keys under the panel, has been proposed (Jpn. Pat. Appln. KOKAI Publication No. 6-62478). However, since such double actions complicate the operation method, the operability does not necessarily improve for unaccustomed users.

On the other hand, in order to improve the operability, a device which outputs a corresponding menu window when the user touches a touch panel and allow the user to make remote control operations on the window has been proposed (Jpn. Pat. Appln. KOKAI Publication No. 6-78381). With the device of Jpn. Pat. Appln. KOKAI Publication No. 6-78381, when the user touches an arbitrary portion of a flat touch switch formed on a remote controller main body, similar menu window areas which have one-to-one correspondence with operation areas divided in this flat touch switch are displayed. If the user touches a corresponding portion of the flat touch switch to select a channel, the display color of a corresponding item on the menu window is controlled to be different from that of other items. Then, the user can visually recognize the touch switch he or she touched based on the window display, and can confirm the item he or she is about to select.

With the devices of Jpn. Pat. Appln. KOKAI Publication Nos. 6-62478 and 6-78381, even when the identification color of a touch operation is changed and displayed on the window, if a touch feeling on the touch panel remains unchanged, it is not easy for the user to sensorily learn the button positions. Since a normal touch panel structure has electrodes in the X- and Y-directions on a flat panel, it is not suited for remote controllers of a general TV, tuner (set-top box), and the like on which buttons with convex or concave shapes are arranged. In addition, if many options are provided, the number of operation buttons increases. Even if some operation functions are stored in a memory, and the stored functions are switched by operation buttons, the number of operation buttons to be laid out is limited, and an enter key must be operated after the user confirms the function input wait state on the window and the operation button of the remote controller. In this case, an unaccustomed user must repetitively gaze the window and remote controller operation surface, and the operability is not necessarily high.

With the window display using the touch panel and the remote controller that adopts double-action keys, various functions can be provided to operation keys on a limited space, and the operability can be improved than it was since window display corresponding to key operations is used together. However, complicated key operations due to too many functions impair visibility and ease of key operations for the user.

### BRIEF SUMMARY OF THE INVENTION

With a display operation method adopted in an input guide display operation system according to an embodiment of the present invention, an instruction device (remote controller 200 with multi-action keys) that allows one instruction input unit (remote-controller keys 210) to make a plurality of different kinds of operations (touch input, push input, click input, and the like), and a display device (300) which makes display (remote-controller GUI) corresponding to an instruction by this instruction device are used. With this method, if a first operation (touch) of the plurality of different kinds of operations is made on the instruction input unit 210 (Yes in step ST204), a first display (display in response to key touch) corresponding to this first operation is made on the display device (300) (step ST308; step ST308a). If a second operation (push) different from the first operation (touch) is made at the instruction input unit on the first display (display in response to key touch) (Yes in step ST210), a second display including information associated with the first display is made (step ST312; step ST312a). Alternatively, a predetermined action (tuning or the like) is taken in response to the second operation (push) (steps ST312b and ST312c).

Since one instruction input unit (remote-controller keys) allows a plurality of different kinds of operations (touch input, push input, click input, and the like), various user operations can be made even by the instruction device (remote controller) with a limited operation space. In such case, the operation contents are complicated and the visibility/ease of user operation inputs tends to deteriorate. However, since the first display corresponding to the first operation (touch) and the second display or action corresponding to the second operation (push) are used together, the visibility/ease of user operation inputs can be improved.

Furthermore, since displays to be output in correspondence with the first operation (touch) and/or the second operation (push) are hierarchized (for example, an on-screen display layer in FIG. 16 is switched to an on-screen display layer in FIG. 17), further complicated operations can be supported while maintaining high visibility/ease of user operation inputs.

### BRIEF DESCRIPTION OF THE SEVERAL VIEWS OF THE DRAWING

FIG. 1 is a block diagram for explaining a digital TV which comprises an input guide display operation system according to an embodiment of the present invention;

FIG. 2 is a diagram for explaining an example of the arrangement of a remote controller used in the TV shown in FIG. 1;

FIG. 3 is a diagram for explaining a practical example of a double-action key (double-structure button) used in the remote controller shown in FIG. 2;

FIG. 4 is a circuit diagram for explaining an example of a detection circuit for the double-action key (double-structure button) used in the remote controller shown in FIG. 2;

FIG. 5 is a view for explaining a display example (part 1) on the TV in FIG. 1;

FIGS. 6A and 6B are views for explaining a display example (part 2) on the TV in FIG. 1;

FIGS. 7A and 7B are views for explaining a display example (part 3) on the TV in FIG. 1;

FIGS. 8A and 8B are views for explaining a display example (part 4) on the TV in FIG. 1;

FIG. 9 is a flowchart for explaining the control sequence of remote-control operations for the TV shown in FIG. 1;

FIG. 10 is a flowchart for explaining a practical example of a key touch process in the control sequence shown in FIG. 9;

FIG. 11 is a flowchart for explaining a practical example (part 1) of a key push process in the control sequence shown in FIG. 9;

FIG. 12 is a flowchart for explaining a practical example (part 2) of a key push process in the control sequence shown in FIG. 9;

FIG. 13 is a flowchart for explaining a practical example (part 3) of a key push process in the control sequence shown in FIG. 9;

FIGS. 14A and 14B are views for explaining a display example (part 1) in the control sequence shown in FIG. 9;

FIGS. 15A and 15B are views for explaining a display example (part 2) in the control sequence shown in FIG. 9;

FIGS. 16A and 16B are views for explaining a display example (part 3) in the control sequence shown in FIG. 9;

FIGS. 17A and 17B are views for explaining a display example (part 4) in the control sequence shown in FIG. 9;

FIGS. 18A and 18B are views for explaining a display example (part 5) in the control sequence shown in FIG. 9;

FIGS. 19A and 19B are views for explaining a display example (part 6) in the control sequence shown in FIG. 9;

FIGS. 20A and 20B are views for explaining a display example (part 7) in the control sequence shown in FIG. 9;

FIGS. 21A and 21B are views for explaining a display example (part 8) in the control sequence shown in FIG. 9; and

FIGS. 22A and 22B are views for explaining a display example (part 9) in the control sequence shown in FIG. 9.

### DETAILED DESCRIPTION OF THE INVENTION

(Overview)

Normally, upon watching a TV (television) or the like, the viewer (user) stays at a distance from the screen. For this reason, when character keys are prepared on a remote controller like a system remote controller, the user must press keys by visually checking the key layout on the remote controller, and must then confirm characters input characters on the TV screen. However, the user must frequently move the line of sight between the TV screen and remote control panel, resulting in complicated input operations. When the user wants to make operations such as character inputs using a remote controller, it is convenient for the user to input characters without looking way from the screen. When the Internet contents are displayed on the TV, character strings may be displayed on the screen to prompt the user to select them. However, similar complication is involved in such case.

In order to reduce such complicated user input operations, according to an embodiment of the present invention, buttons which have a double structure (two-storied structure) of touch switches having a touch detection function and push switches having a push detection function (buttons having convex and/or concave patterns are preferable so that the user can perceive them by blind touch even in a dark room with dimmed lights) are arranged. With a button operation on such remote controller, a GUI having a key layout pattern of the remote controller is displayed on the TV screen (as OSD data). The user can visually recognize a button that he or she touched (a kind of icon on the GUI) on the basis of its color, shape, contrast from the surrounding portion, and/or icon animation from the screen on the GUI in the OSD display state.

Furthermore, each button can have a click detection function of re-clicking (or double-clicking). In this case, when channels assigned to respective buttons are displayed as a remote-controller map (remote-controller maps on the GUI are hierarchically switched as needed), the user can select a channel by a simple click operation while confirming the channel setups of respective buttons.

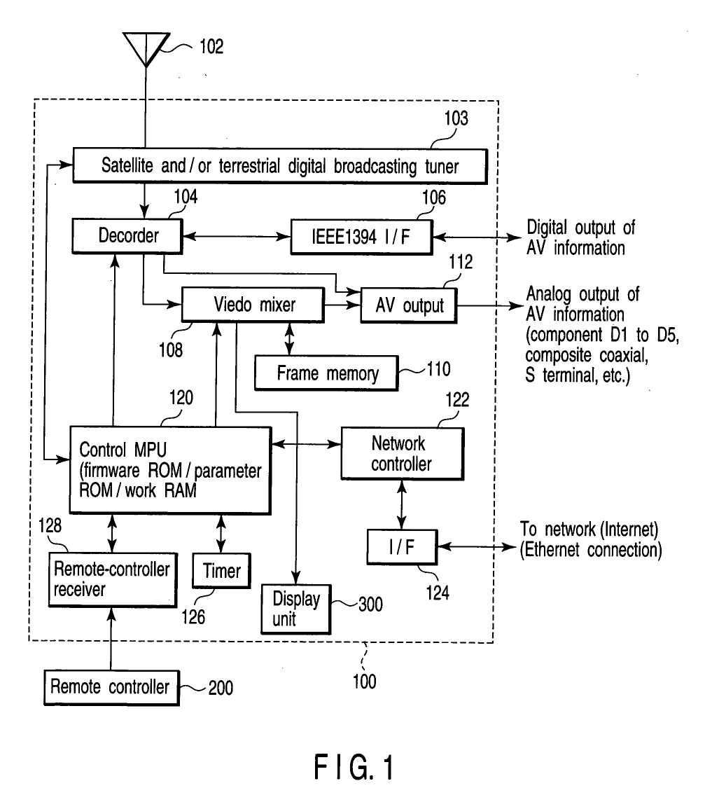

An embodiment of the present invention will be described below with reference to the accompanying drawings. FIG. 1 is a block diagram for explaining the arrangement of digital TV 100 which comprises an input guide display operation system according to an embodiment of the present invention. TV antenna (analog terrestrial broadcasting VHF/UHF antenna, digital terrestrial broadcasting UHF antenna, analog/digital satellite broadcasting BS antenna, and the like) 102 is connected to satellite and/or terrestrial digital broadcasting tuner 103 (an analog tuner is not shown). MPEG digital information (video, audio, service information, and the like) received by tuner 103 is decoded by MPEG decoder 104. MPEG digital information before decoding is externally output via IEEE 1394 interface 106. Decoded video signal components are sent to video mixer 108.

Video mixer 108 superimposes GUI information from control MPU 120 as OSD display on the video signal from decoder 104 at a predetermined contrast ratio (e.g., 50%). Frame memory 110 is used as needed to superimpose GUI information. The video signal on which the GUI information is superimposed for OSD display is sent to display unit (a TV monitor such as a liquid crystal display, plasma display, CRT, or the like) 300, and is displayed on its screen. Furthermore, the video signal on which the GUI information is superimposed for OSD display is mixed with a decoded audio signal by AV output circuit 112, and is externally output as an analog AV signal. As this external output video terminal, component output terminals (D1 to D5 terminals), composite coaxial terminal, or S terminal may be used in accordance with an apparatus to be externally connected. As an audio terminal, a general coaxial terminal can be used.

Control MPU 120 is connected to network controller 122, which is connected to a home network line via interface 124. In this case, for example, the home network line uses Ethernet(R). A router (not shown) of this network is connected to the Internet via, e.g., a broadband compatible modem. This router has a plurality of hubs to which a personal computer (PC), video recorder (DVD-VR recorder), and external tuner (set-top box STB incorporating a satellite and/or terrestrial digital tuner or another digital TV) can be connected via the network (Ethernet), although not shown. With this arrangement, for example, electronic program guide information (EPG information) can be downloaded by accessing an EPG site (Internet EPG) on a Web.

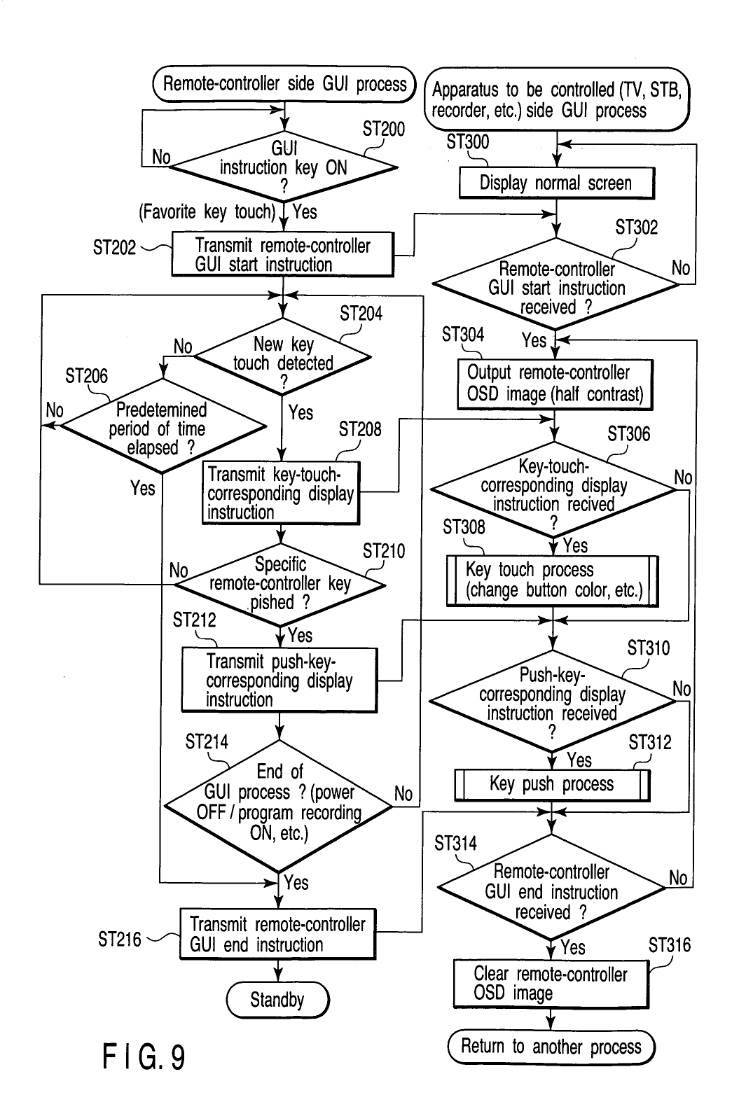

Control MPU 120 includes a ROM that stores firmware (control programs corresponding to the flowcharts in FIGS. 9 to 13 to be described later and the like) required to execute various kinds of control, a ROM that stores data and/or parameters used upon executing various kinds of control, a RAM that provides a work area upon executing firmware, and the like. Timer 126 and remote-controller receiver 128 are connected to this MPU 120. When remote-controller receiver 128 receives a user operation from external remote controller 200, it sends the user operation signal to MPU 120. In response to this signal, MPU 120 makes OSD display and apparatus control according to the user's remote-control operation.

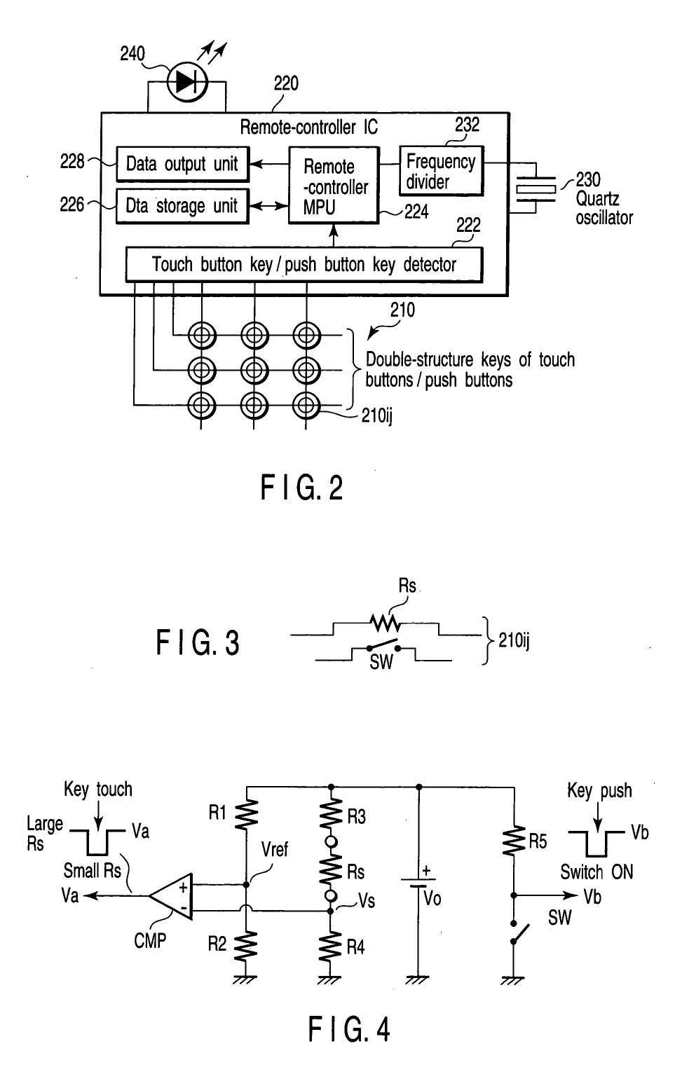

FIG. 2 is a diagram for explaining an example of the arrangement of remote controller 200 used in TV 100 shown in FIG. 1, and exemplifies its internal circuit arrangement. Remote-controller buttons 210 (the number of buttons is i×j in this example) have a double structure of touch and push buttons, and are laid out in an i×j matrix. Note that each touch button (touch sensor Rs) and push button (push sensor SW) have independent detectors. Remote-controller IC 220 has touch button/push button switch detector 222. This detector 222 can be arranged as follows. That is, a difference is set between the detection level upon touching each touch button, and that upon pushing each push button, and which of the touch and push buttons is touched or pushed is identified based on that level difference.

A state detected by each individual button 210 via detector 222 with such arrangement is recognized by remote-controller MPU 224. Remote-controller MPU 224 operates using signals frequency-divided by an oscillation signal generated by quartz oscillator 230 as clocks. MPU 224 reads out remote-controller transmission data corresponding to a button detected via detector 222 from data recording unit 226, and transmits the readout remote-controller transmission data to data output unit 228. Then, output unit 228 supplies a pulse train of currents corresponding to the transmission data to infrared light-emitting diode 240, and a remote-controller operation signal corresponding to this pulse train is transmitted to remote-controller receiver 128 in FIG. 1.

FIG. 3 is a diagram for explaining a practical arrangement of a double-action key (double-structure button) on remote controller 200 in FIG. 1 or 2. Each button 210ij has, e.g., a convex-pattern surface so that it can be perceived by blind touch. A touch sensor (pressure-sensitive resistor element Rs using a conductive resin or the like) is arranged immediately below each convex button, and a push sensor (metal switch SW which is turned on a pressure more than touch) is arranged below that touch sensor. The touch sensor detects touch to that button by detecting a change in impedance of element RS due to a change in external force to the corresponding button.

FIG. 4 shows an example of a detection circuit of the double-action key (double-structure button) on remote controller 200 in FIG. 1 or 2. In this circuit, reference voltage Vref generated by dividing DC power supply voltage Vo by resistors R1 and R2 is supplied to the non-inverting input of comparator CMP, and comparison voltage Vs generated by dividing DC power supply voltage Vo by resistors R3+Rs and R4 is supplied to the inverting input of comparator CMP. When Vs obtained by pressure-sensitive resistor element Rs (large DC resistance) without any button touch is slightly lower than Vref, output Va from comparator CMP is high level (e.g., +5V). On the other hand, if the DC resistance (electrical impedance in a broad sense) of pressure-sensitive resistor element Rs is reduced by button touch, Vs obtained at that time becomes higher than Vref. As a result, output Va from comparator CMP changes to low level (e.g., +1V), and button touch (key touch) can be detected from this change.

DC power supply voltage Vo is connected to switch SW via resistor R5. When switch SW is OFF, voltage Vb of a node between RS and SW is at high level (e.g., +5V). When switch SW is turned on by button push, voltage Vb changes to low level (e.g., 0V). Hence, button push (key push) can be detected from this change. Whether key touch or key push is detected can be discriminated based on the difference between low levels (+1V and 0V in the above example) of detected voltages Va and Vb.

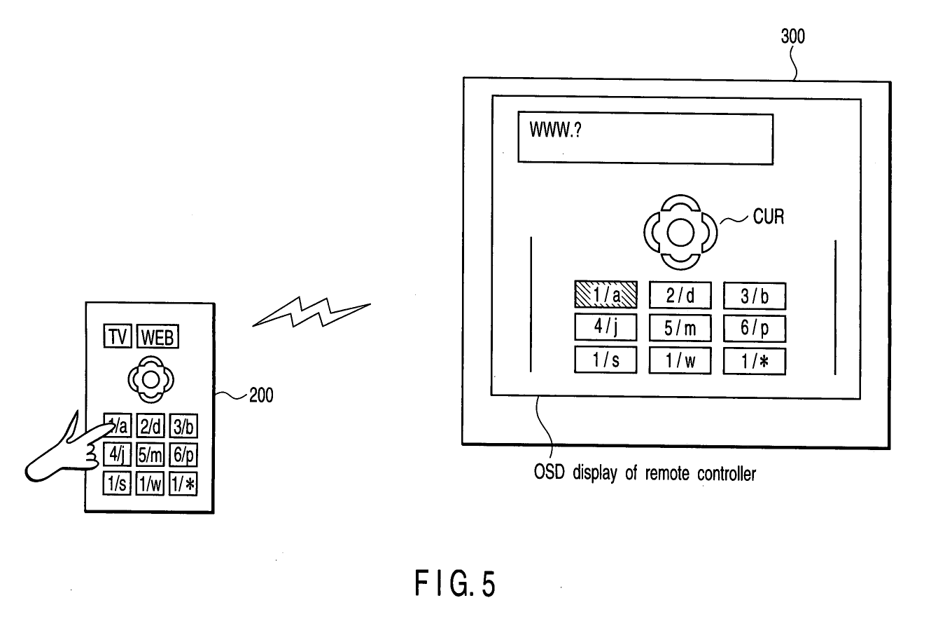

FIG. 5 is a view for explaining a GUI display example (part 1) on TV 100 in FIG. 1. FIG. 5 exemplifies a state wherein a remote-controller map is displayed on the TV screen (display unit 300) in response to a finger that touched a touch button on remote controller main body 200 with the double structure of touch and push switches, and button touch is detected. The screen display at that time is based on an object that imitates a graphic image of remote controller 200, and the button notation contents of remote controller 200 can be switched according to the use state. Note that the use state indicates a case wherein the user is watching a BS, CS, or terrestrial digital/analog broadcasting program, a state wherein the user is accessing the Internet, a state that requires character inputs, and the like.

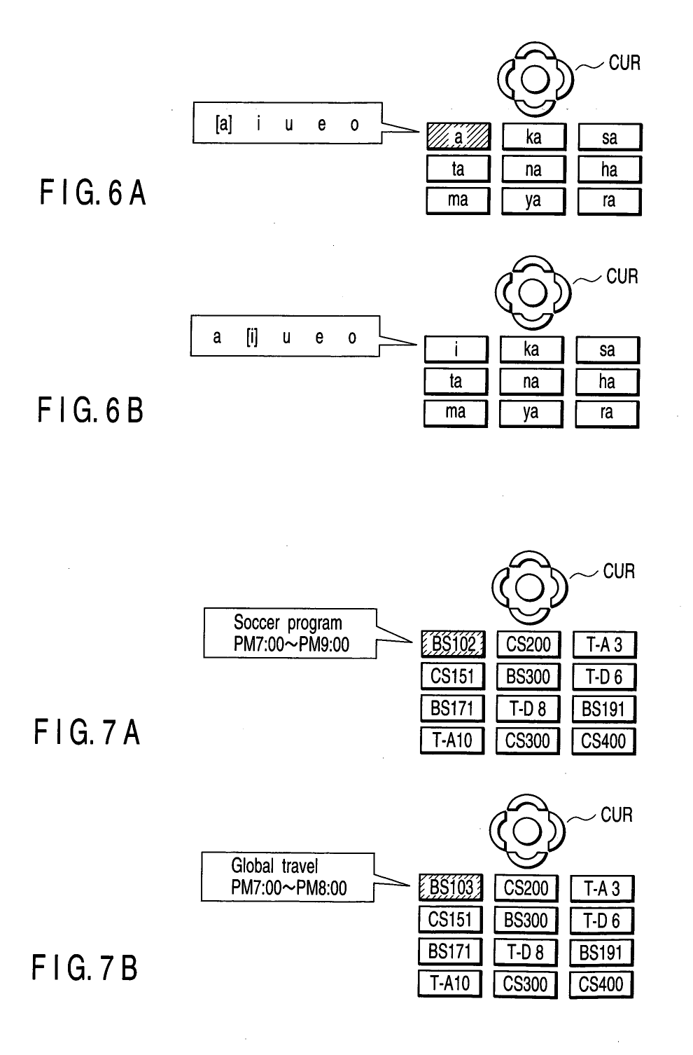

FIGS. 6A and 6B are views for explaining a GUI display example (part 2) on TV 100 in FIG. 1. In this case, when the user touches a touch button, a character string assigned to that button is displayed, and the display color of that button is changed (in the example of FIG. 6A, the color of “a” changes). Furthermore, by pushing a push button at the touch-sensed position, a character assigned to that button can be switched and displayed (in the example of FIG. 6B, a character display “a” is switched to “i”). Also, while a character string is displayed, a character to be selected can be changed using cursor keys CUR. After a character is selected using the cursor, an enter button at the center of cursor keys CUR is selected, thus determining that character (for example, when the user pushes a remote-controller key corresponding to the enter button arranged at the center of cursor keys CUR in the state of FIG. 6A, “a” is determined as an input character).

Alternatively, if a predetermined period of time has elapsed after touch of the touch button, an input character may be automatically determined. More specifically, if 30 sec have elapsed in the state of FIG. 6A without any user operation, “a” is automatically determined as an input character. The elapsed time at that time can be detected, e.g., when MPU 120 continuously monitors timer 126 in FIG. 1.

FIGS. 7A and 7B are views for explaining a GUI display example (part 3) on TV 100 in FIG. 1. FIGS. 7A and 7B show a display example of a remote-controller map upon selecting a program during program viewing. When the user's finger touches a given tuning key, the color of that button on the screen changes, and the broadcasting contents of a channel assigned to that button are displayed on the screen (see the left balloon in FIG. 7A or 7B). When the user further pushes the bush button from that state, a broadcasting program assigned to that button is displayed on display unit 300. When the user presses the enter key (at the center of cursor keys CUR) while the touch button remains selected and the button color on the screen remains changed, a broadcasting station corresponding to the button whose color has changed is selected.

Alternatively, if a predetermined period of time has elapsed after touch of the touch button, a corresponding station may be selected. More specifically, if 30 sec have elapsed in the state of FIG. 7A without any user operation, a soccer program of “BS102” is automatically selected. Note that a character data table used in OSD display in FIGS. 6A and 6B, FIGS. 7A and 7B, and the like may be stored in the parameter ROM in MPU 120 in FIG. 1.

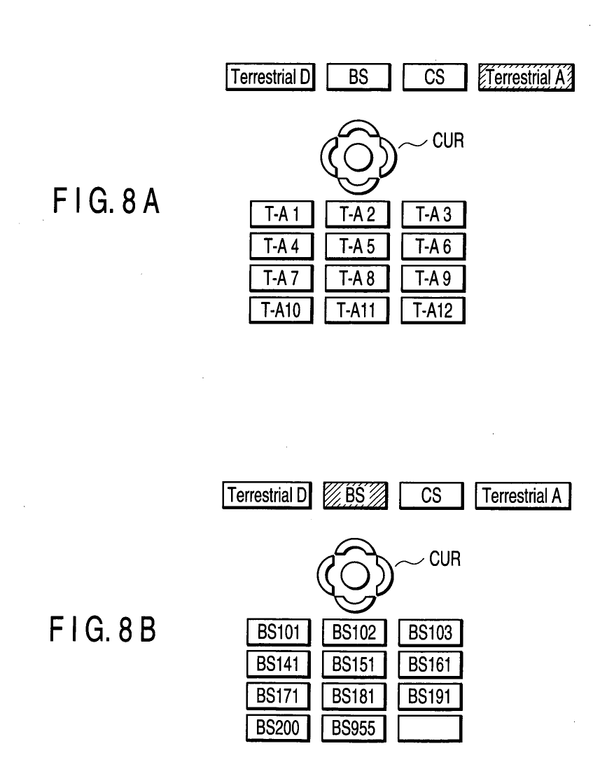

FIGS. 8A and 8B are views for explaining a GUI display example (part 4) on TV 100 in FIG. 1. FIGS. 8A and 8B show another display example of a remote-controller map upon selecting a program during program viewing. Upon depression of a given direct key of each broadcasting wave assigned to remote controller 200 (terrestrial A in the example of FIG. 8A; BS in the example of FIG. 8B), a remote-controller map corresponding to the pressed key is displayed on the screen. More specifically, a direct tuning button map (T-A1 to T-A12 in the example of FIG. 8A; BS101 to BS955 in the example of FIG. 8B) corresponding to the broadcasting wave of the pressed direct key is displayed.

In addition, as the OSD display method of a remote-controller map, when direct channel setups with assignment shown in FIGS. 7A and 7B or FIGS. 8A and 8B are available, a corresponding remote-controller map may be displayed (a kind of resume display) in a last mode in which the user selected a channel last by operating each direct tuning button. Furthermore, tuning channels of respective buttons may be selected by selecting genres such as movie, sports, music, and the like. More specifically, when the user selects a button or GUI that selects genre setups, channels that can be viewed at that time (e.g., channels of sport programs) can be assigned to direct buttons for respective sports. As a result, a favorite sport program of each user can be easily selected, and its selection can be done quickly. Furthermore, by re-clicking (or double-clicking a button that selects genre setups, selectable programs of, e.g., sports→cooking→animation→drama→ . . . can be displayed while being assigned to direct buttons. In this way, convenience can be improved.

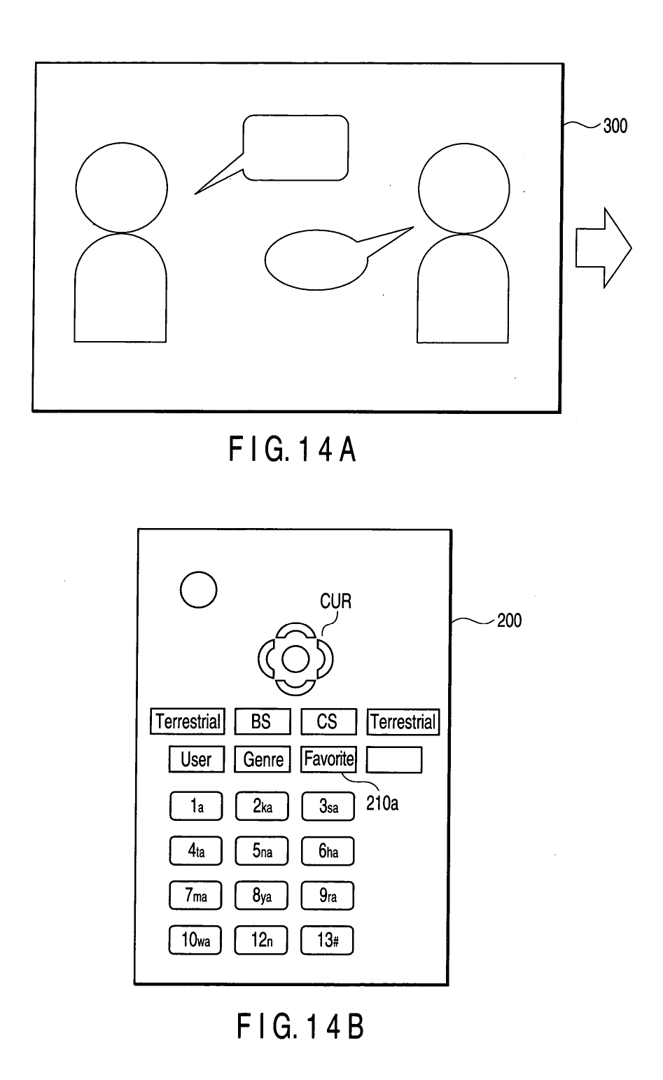

FIG. 9 is a flowchart for explaining the control sequence of the remote-control operation in TV 100 shown in FIG. 1. FIGS. 14A to 22B are views for explaining display examples and the like in the control sequence shown in FIG. 9.

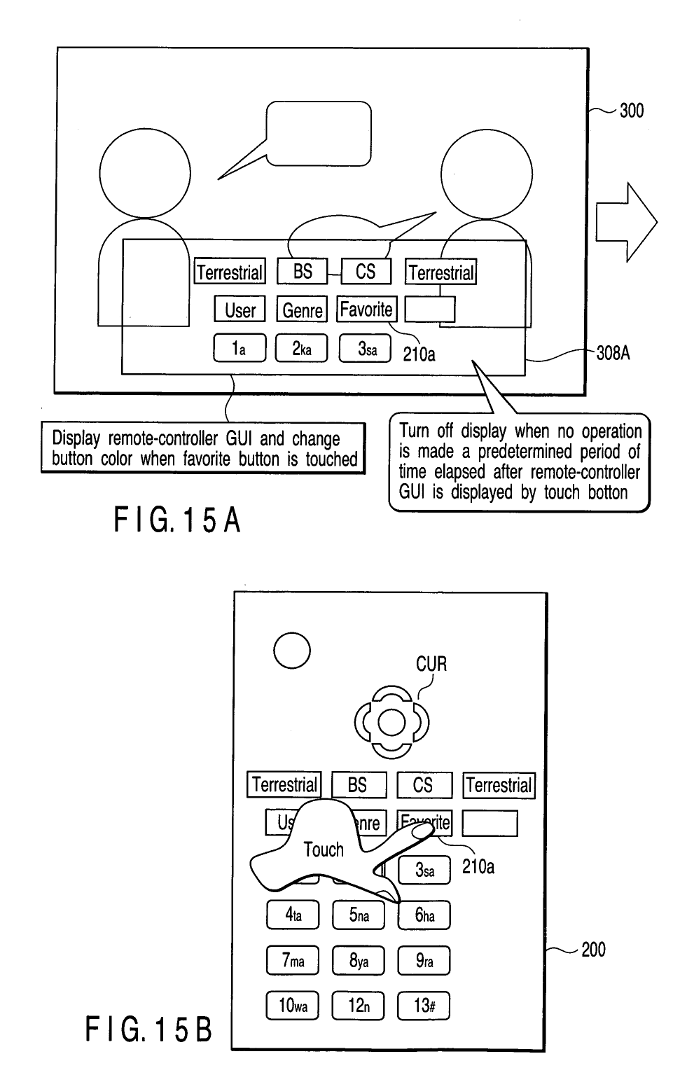

Remote controller 200 in FIGS. 1 and 2 has “favorite key 210a” shown in, e.g., FIG. 14B. If the user touches this favorite key 210a, a remote-controller GUI start instruction is issued. That is, if a GUI instruction key is turned on (in this case, if favorite key 210a shown in, e.g., FIG. 15B is touched) (Yes in step ST200 in FIG. 9), remote controller 200 transmits a remote-controller GUI start instruction to remote-controller receiver 128 of TV 100 (step ST202). Note that the GUI instruction key is not limited to favorite key 210a, and any of remote-controller keys (or buttons) with a key touch detection function can serve as the GUI instruction key.

On the other hand, display unit 300 on the TV 100 side as an apparatus to be controlled by remote controller 200 makes a normal screen display (e.g., FIG. 14A) after power ON (step ST300). If remote-controller receiver 128 receives the GUI start instruction from remote controller 200 (Yes in step ST302), a remote-controller image (e.g., 308A in FIG. 15A) as a graphic image similar to the key map of the remote controller on hand of the user is output as OSD data (step ST304). This remote-controller OSD image may completely cover a normal image under it (in this case, the contrast of the remote-controller image is 100%). In this case, in order to leave the normal screen display within the visual range of the remote-controller image, the remote-controller image is output at a contrast of about 50% (in FIG. 15A, remote-controller OSD image 308A is a semitransparent image corresponding to the contrast 50%).

If a new touch (first touch) is detected on a given remote-controller key (favorite key 210a first) with a key touch detection function (Yes in step ST204), remote controller 200 transmits a display instruction corresponding to the touched key (or key touch) (step ST208). If remote-controller receiver 128 receives the display instruction corresponding to the key touch from remote controller 200 (Yes in step ST306), a key touch process is executed (step ST308), and the color or the like of a button graphic image (or icon) on the OSD display corresponding to the touched key is changed (see FIG. 15A). In this way, the user can confirm a remote-controller key that he or she touched without looking away from the screen of the display unit 300.

After that, if a predetermined period of time (e.g., about 1 to 5 sec) has elapsed (Yes in step ST206) without depression of any remote-controller key (No in step ST210) or without any new key touch (No in step ST204), remote controller 200 transmits a remote-controller GUI end instruction to remote-controller receiver 128 (step ST216), and the control routine on the remote controller 200 side enters a standby mode. If remote-controller receiver 128 receives the remote-controller GUI end instruction from remote controller 200 (Yes in step ST314), the remote-controller OSD image is cleared (step ST316), and the control routine on the TV (apparatus to be controlled) 100 side returns to another process.

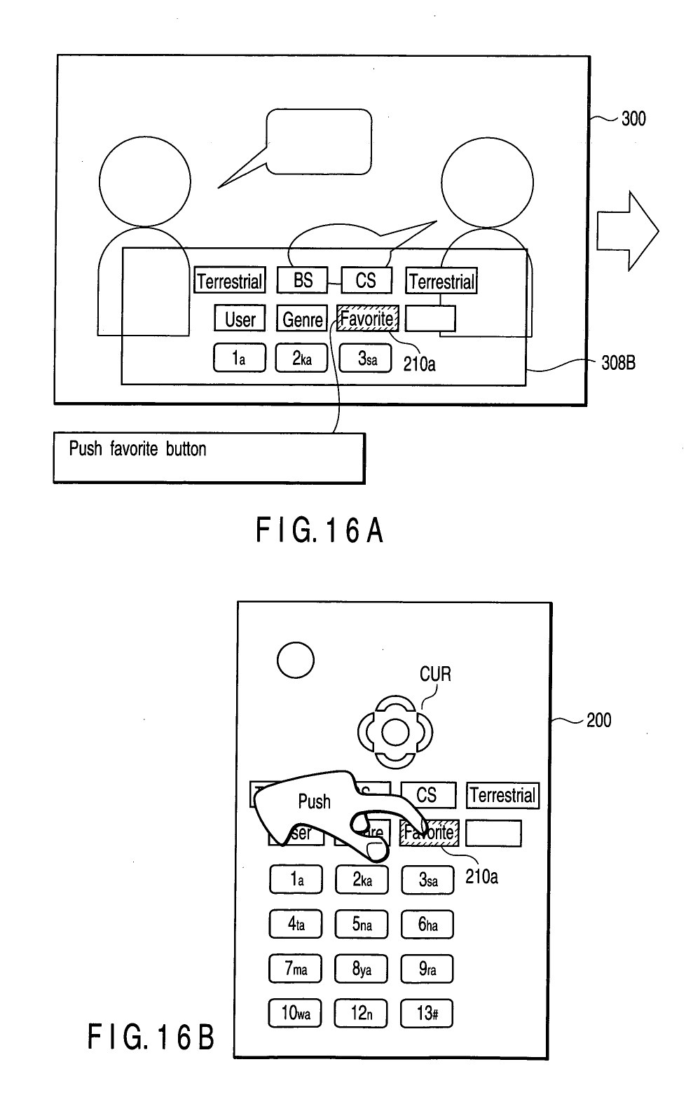

On the other hand, if the user presses one of remote-controller keys (Yes in step ST210) (if the user pushes favorite key 210a in the example of FIG. 16B), a display instruction corresponding to the pressed key (push key) is transmitted (step ST212). If remote-controller receiver 128 receives the display instruction corresponding to the push key from remote controller 200 (Yes in step ST310), a key push process is done (step ST312), and remote-controller OSD image 308B on display unit 300 changes accordingly (FIG. 16B).

After that, if the user issues a GUI process end instruction by turning on a power key, program recording key, or the like (not shown) on remote controller 200 (Yes in step ST214), a remote-controller GUI end instruction is transmitted (step ST216), and the control routine on the remote controller 200 side enters a standby mode. If remote-controller receiver 128 receives the remote-controller GUI end instruction from remote controller 200 (Yes in step ST314), the remote-controller OSD image is cleared (step ST316), and the control routine on the TV (apparatus to be controlled) 100 side returns to another process. While the GUI process is not to end (No in step ST214), the TV 100 side executes a corresponding process (steps ST308 and ST312) every time a key touch and/or key push on remote controller 200 are/is made.

In the process shown in FIG. 9, the control may enter the remote-controller GUI display process after the first key touch on the remote controller. In this case, if the first key touch is detected (Yes in step ST200), the checking process in step ST306 may be skipped, and the process in step ST308 may be executed immediately after step ST304.

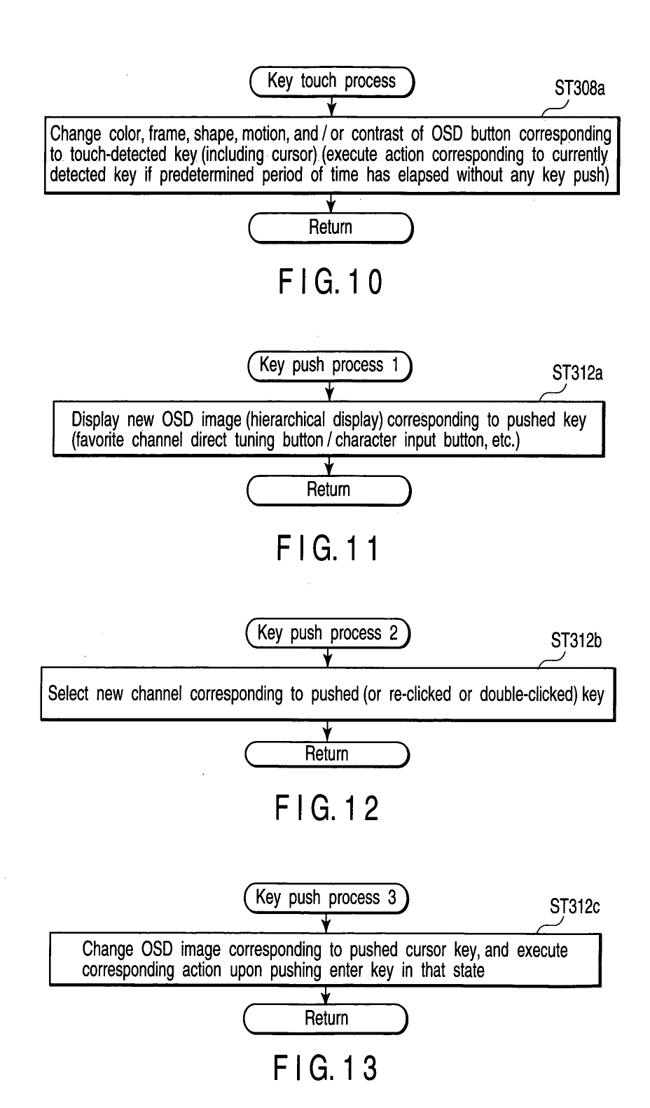

FIG. 10 is a flowchart for explaining a practical example of the key touch process (step ST308) in the control sequence shown in FIG. 9. In the key touch process (step ST308a) in FIG. 10, the color, frame (bordering), shape, motion, and/or contrast of an OSD display button (or icon) corresponding to a key (button or cursor) touched by the user's finger tip are/is changed. For example, if the user touches favorite button 210a in FIG. 15B, the color of the OSD image (or icon) of favorite button 210a in FIG. 15A changes to a striking color (e.g., bright red). If a predetermined period of time has elapsed without any user's key operation, an action (tuning) corresponding to the detected key (e.g., a key for designating a specific broadcasting station) at that time may be automatically executed in the process of FIG. 10.

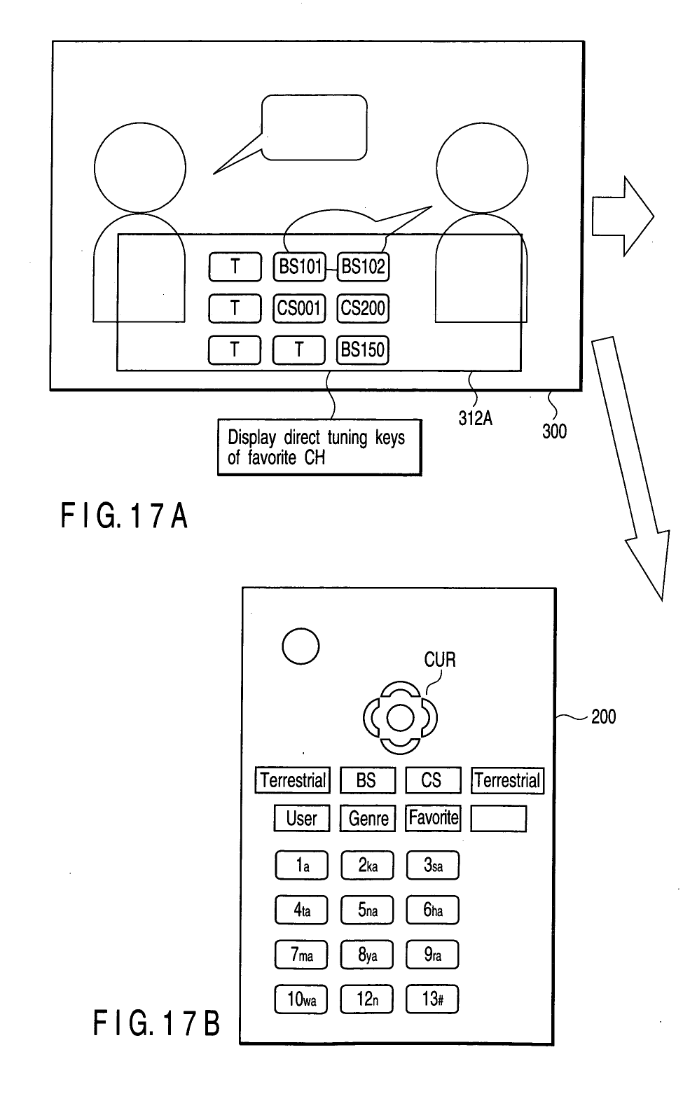

FIGS. 11 to 13 are flowcharts for explaining practical examples of the key push process (step ST312) in the control sequence shown in FIG. 9. In the processing example of FIG. 11, if the user pushes one of remote-controller keys under the OSD display of the remote-controller GUI corresponding to the key touch (e.g., FIG. 16A), OSD image 312A of a new remote-controller GUI corresponding to the pushed key (e.g., favorite key 210a in FIG. 16A) is displayed (e.g., channel direct tuning buttons in FIG. 17A) (step ST312a). A change in OSD display from FIG. 16A to FIG. 17A is made under the hierarchized OSD display control.

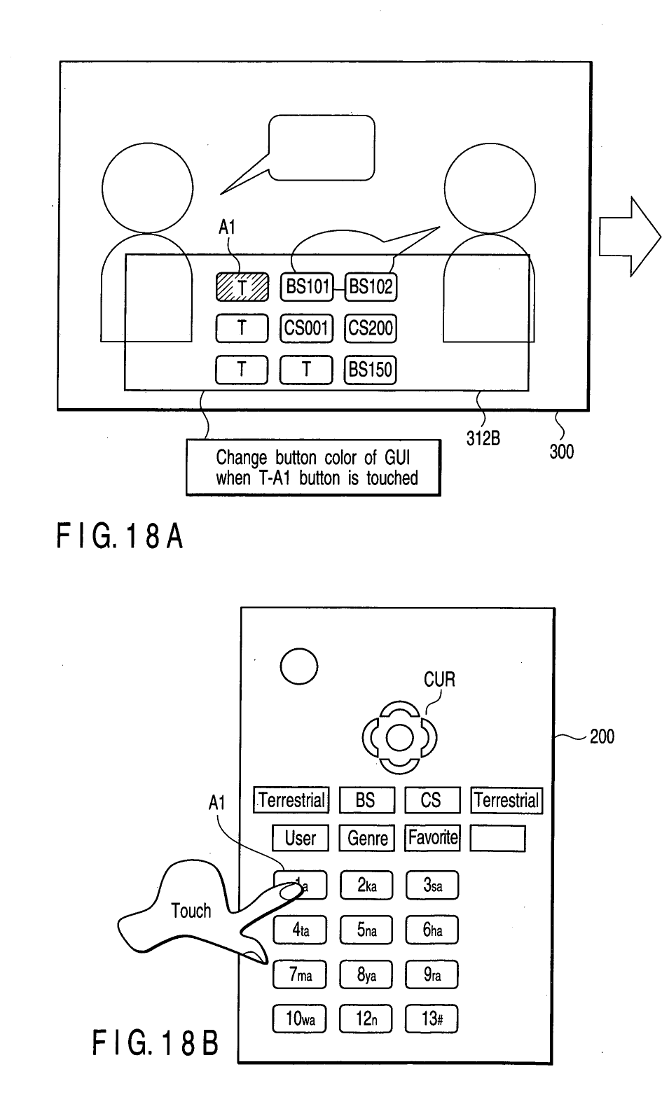

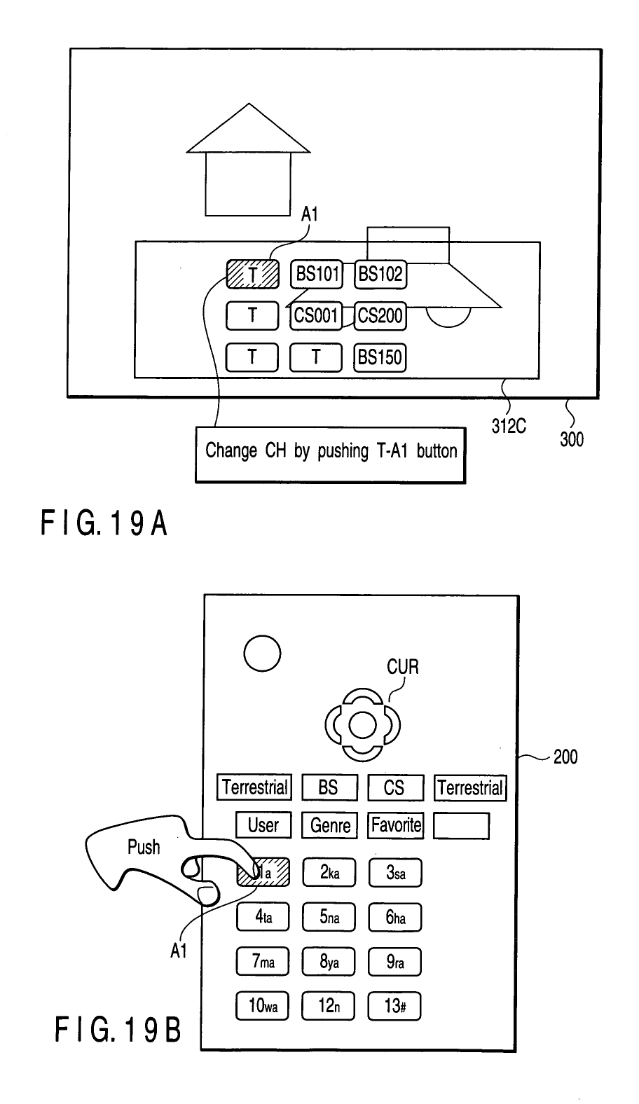

In the processing example in FIG. 12, if the user pushes (re-clicks or double-clicks) a given key, a new channel corresponding to that key operation is selected (step ST312b). If the user touches remote-controller key A1 in FIG. 18B while remote-controller OSD image 312B in FIG. 18A is displayed, the color of button T-A1 on remote-controller OSD image 312B is changed (the key touch process in step ST308). In this state, if the user pushes remote-controller key A1 in FIG. 19B, for example, terrestrial analog broadcasting channel 1CH is selected, and a TV reception image (display on display unit 300) as a background of remote-controller OSD image 312C in FIG. 19A is switched to an image of 1CH.

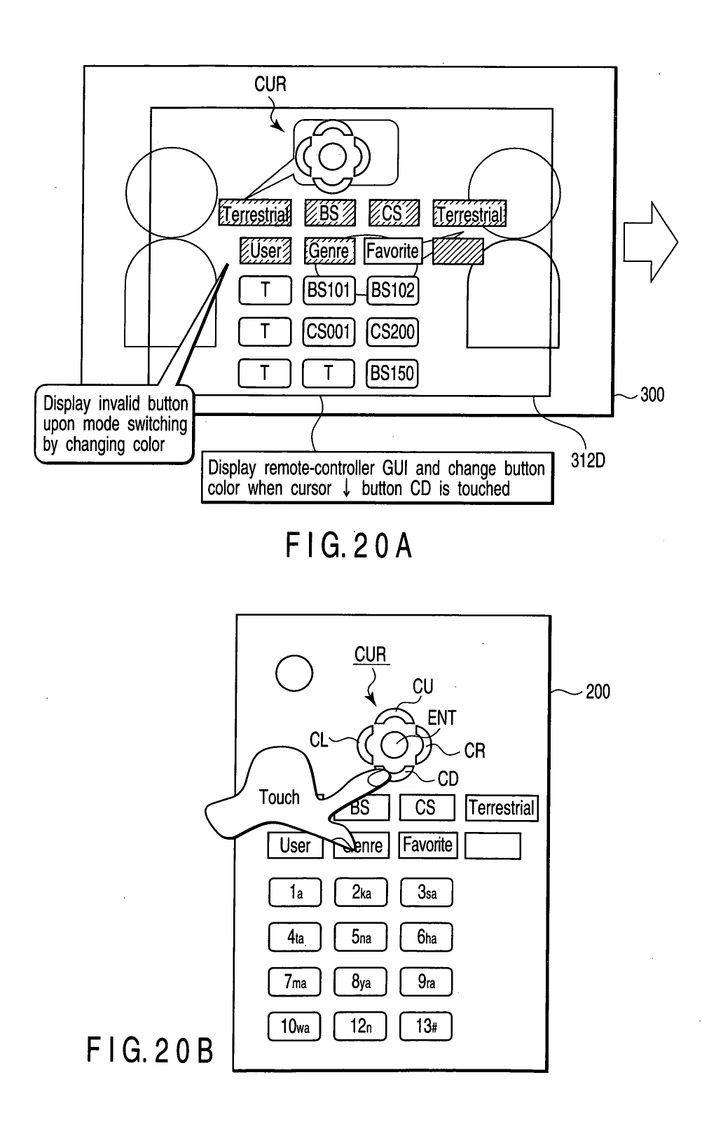

In the processing example of FIG. 13, an OSD image to be displayed corresponding to a pushed cursor key is changed, and a corresponding action upon pushing of the enter key in that state is made (step ST312c). For example, if the user touches one of cursor keys CUR in FIG. 20B, a remote-controller OSD image is switched to a corresponding screen image (FIG. 20A). In this state, a color change portion of buttons on remote-controller OSD image 312D moves in correspondence with key touch to one of up, down, right, and left keys (CU, CD, CR, and CL) of cursor keys CUR (key touch process in step ST308). In such case, invalid keys that cannot be operated upon this cursor operation may be displayed as ghost keys, their colors may be changed to a special color, or an X mark may be superimposed, thus preventing the user from confusing upon operation.

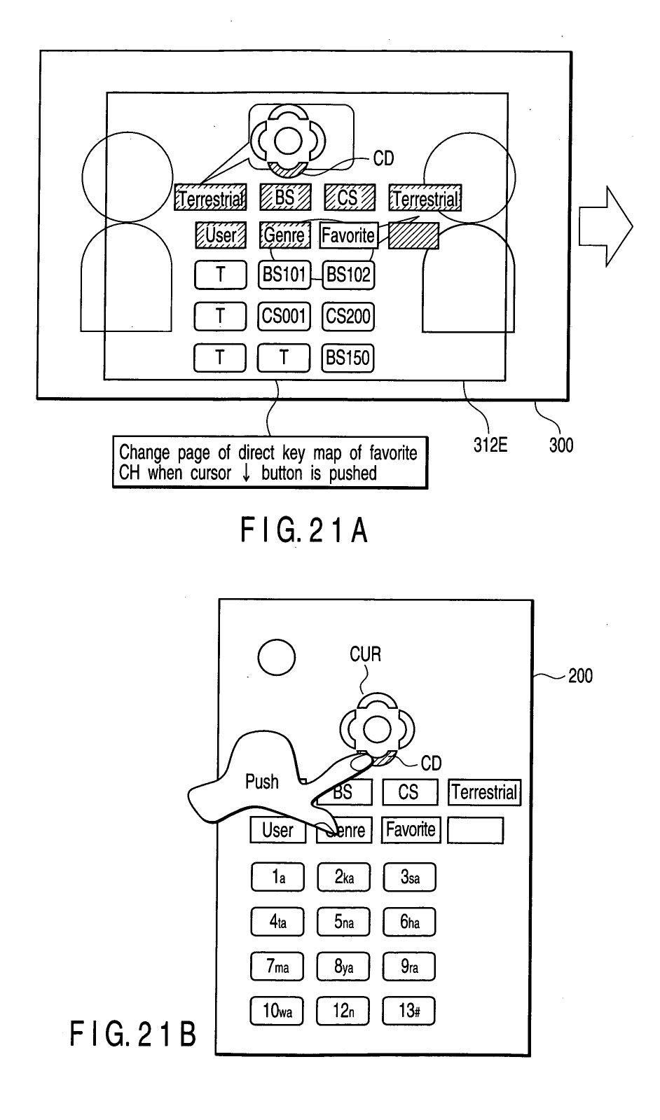

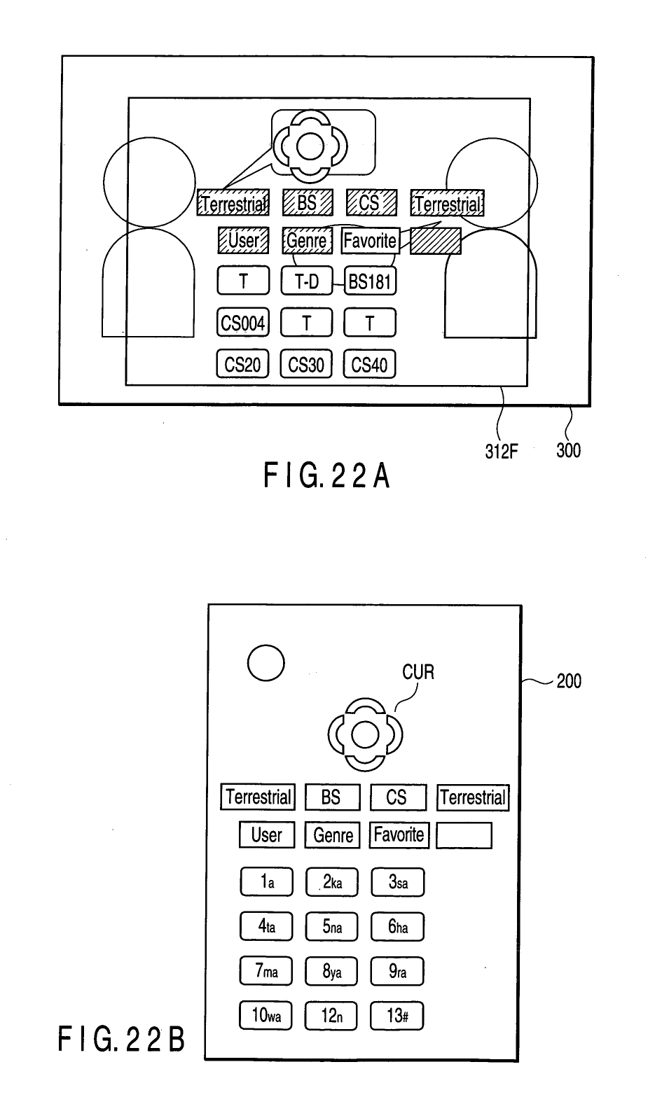

If the user pushes a specific cursor key (e.g., down (↓) cursor key CD in FIG. 21B), remote-controller OSD image 312E (FIG. 21A) on display unit 300 is changed to an image (e.g., a GUI page including a direct key map of favorite channels . . . OSD image 312F in FIG. 22A or the like) corresponding to a button whose color has changed as that of a “valid key” at that time (a GUI display page change action is executed). If the color of a desired button is changed by key touch and is pushed in such state, an action (tuning or the like) of the pushed button is executed.

### Summary of Embodiment

1. Buttons (which preferably have concave and/or convex patterns to realize blind touch), which have a double structure of button switches and push switches having a touch detection function, are arranged on a remote controller, and an OSD image of a GUI as a graphic image of a remote-controller map is displayed on the TV screen. In this display state, the user can visually recognize a button that he or she touched by changing the color or shape on the GUI.

2. The remote-controller map on the GUI is assigned a function of displaying button notations themselves of the remote controller, a function of identifiably displaying a selected program assigned to a given button, and a function of switching display of a program assigned to that button upon pushing the button (a display function that can be hierarchically switched). When the user presses an enter key while selected station information of the button is displayed on this GUI, the selected program is switched.

3. When programs assigned to respective buttons by the above function are displayed, and button switches having the touch detection function are enabled, if the push switch remains unchanged for a predetermined period time, the function finally selected by the push switch is automatically executed.

4. While the user is watching the TV, direct tuning buttons of broadcasting channels are assigned to remote-controller buttons. However, when the user uses the Internet (WWW) or mail function, and a GUI that must use a character input function assigned to the remote controller appears, characters assigned to respective buttons are displayed at the display positions of respective buttons to allow character inputs.

5. When no new touch is detected within a predetermined period of time after touch is detected by a given button switch having the touch detection function (for example, when the user releases the remote controller and leaves it for a predetermined period of time or more), the OSD image of the GUI displayed on the TV screen is automatically cleared. After the OSD image is cleared, if new touch is detected again, the OSD image of the GUI is re-displayed on the TV screen. In this case, if the OSD display state immediately before it is cleared is memorized (resume function), the re-displayed OSD image can automatically resume the state immediately before it is cleared. Note that the “OSD display state immediately before it is automatically cleared” can be memorized using the work RAM in MPU 120 in FIG. 1 or a flash memory (or an SRAM backed up by a battery; not shown). On the other hand, when the user ends the OSD display of the GUI, if the OSD image of the GUI is to be displayed for the next time, a default initial OSD image is displayed. This “default initial OSD image” data can be stored in, e.g., the parameter ROM in MPU 120 in FIG. 1.

### Effect of Embodiment

By providing the touch detection function to buttons with concave/convex patterns on a general remote controller of a TV, tuner, or the like, the recognition precision of the button layout can be improved. By adopting the double structure of the touch detection function and push function, a program selected and displayed by a touch-detected button function on the screen can be actually selected by tuning on the corresponding push button. Furthermore, buttons to be displayed on the screen by the touch detection function can be assigned a re-click tuning function (a function of switching a program to be selected every time a button is clicked) in addition to the direct tuning function. With this function, programs of respective broadcasting systems assigned to direct keys can be selected quickly.

Note that the present invention is not limited to the aforementioned embodiments themselves, and can be embodied by variously modifying required constituent elements without departing from the scope of the invention when it is practiced.

For example, the present invention can be practiced when a virtual remote controller + TV are implemented by software on a personal computer. In this case, a mouse can be used to operate buttons of a remote controller displayed as a GUI on the monitor of the personal computer. More specifically, when the mouse pointer is located on an icon of a given touch/push double-action key, the process is made by recognizing that the key under the pointer is touched. If a mouse button is clicked or double-clicked in that state, the process can be made by recognizing that the button is pushed. Also, firmware corresponding to the “remote-controller side GUI process” in FIG. 9 may be installed in an internal MPU of a portable phone, and that portable phone can be used in place of the remote controller.

Also, various inventions can be formed by appropriately combining a plurality of required constituent elements disclosed in the embodiment. For example, some required constituent elements may be deleted from all the required constituent elements disclosed in the embodiment. Furthermore, required constituent elements according to different embodiments may be combined as needed.

1. A display operation method using an instruction device in which a plurality of different types of operations can be instructed via a single instruction input unit, and a display device that makes display corresponding to an instruction issued by the instruction device, said method comprising:
controlling, when a first operation of the plurality of different types of operations is made at the instruction input unit, the display device to make a first display corresponding to the first operation; and
controlling, when a second operation different from the first operation is made at the instruction input unit in the first display, the display device to make a second display associated with the first display or to take an action corresponding to the second operation.

2. A method according to claim 1, wherein if a state wherein no new operation of the first operation is made continues for a predetermined period of time, the display corresponding to an instruction of the instruction device is cleared.

3. A method according to claim 1, wherein if a select instruction is issued from the instruction device while the first display is made, or if a predetermined period of time elapses while the first display is made, an action corresponding to the first display is executed.

4. A method according to claim 2, wherein the action corresponding to the first display includes selection of a broadcasting station corresponding to the first display or a character input corresponding to the first display.

5. An audio/visual apparatus configured to be used together with an instruction device having at least one multi-function key that allows touch and push inputs, and configured to include or to be connected to a display unit that makes an on-screen display corresponding to an instruction from the instruction device, said apparatus comprising:
a first block configured to change a display method in a portion of the on-screen display in response to the touch input from the instruction device; and
a second block configured to display related information on the on-screen display, the display method of which has been changed in response to the touch input, in response to the push input from the instruction device.

6. An apparatus according to claim 5, further comprising
a third block configured to execute an action corresponding to the on-screen display whose display method has been changed, in response to a select instruction from the instruction device while the on-screen display whose display method has been changed in response to the touch input is made, or in response to an elapse of a predetermined period of time while the on-screen display whose display method has been changed in response to the touch input is made.

7. An apparatus according to claim 6, wherein the audio/visual apparatus includes a television receiver that receives at least one broadcasting station, the instruction device includes a remote controller used to operate the television receiver, and the third block allows a user to select a broadcasting station to be received, via the on-screen display.

8. An apparatus according to claim 6, wherein the audio/visual apparatus includes a television receiver that receives at least one broadcasting station, the instruction device includes a remote controller used to operate the television receiver, and the third block allows a user to make a character input, via the on-screen display.

9. A remote-control device configured to remote-control an external apparatus having an on-screen display function, and comprises double-action keys each having a touch sensor and push sensor, said device being configured to:
output, when one of the double-action keys is touched, to the external apparatus a first instruction that changes appearance of the on-screen display at a position corresponding to the key touch; and
output, when the double-action key corresponding to the position whose appearance has been changed by the first instruction is pushed, information corresponding to the pushed key on the on-screen display.

10. A device according to claim 9, wherein the device is configured to output a third instruction that clears the on-screen display in response to a predetermined process end operation or an elapse of a predetermined period of time while no new key touch is made.
